(19) United States
(12) Patent Application Publication
(10) Pub. No.: US 2019/0299317 A1
(43) Pub. Date: Oct. 3, 2019

(54) WELDING SYSTEM

(71) Applicant: TAIYO NIPPON SANSO CORPORATION, Tokyo (JP)

(72) Inventor: Katsunori WADA, Kai-shi (JP)

(21) Appl. No.: 16/315,717

(22) PCT Filed: Jul. 13, 2017
(86) PCT No.: PCT/JP2017/025541

§ 371 Date: Jan. 7, 2019

(30) Foreign Application Priority Data
Jul. 14, 2016 (JP) 2016-139462

(51) Int. Cl. B23K 9/12; B23K 9/10

(52) U.S. Cl. CPC B23K 9/12; B23K 9/1043

(57) ABSTRACT

An object of the present invention is to provide a welding system having a remote controller suitable for manually adjusting the feeding speed of a filler wire, the present invention provides a welding system including: a consumable electrode type or a non-consumable electrode type welding torch (20); a welding power supply device (40) which is configured to supply a welding current to the welding torch (20); a wire feeding device (30) which is configured to feed a filler wire (W) to the welding torch (20) or a filler guide (31) attached to the welding torch (20); a remote controller (50) which is configured to manually adjust a feeding speed of the filler wire (W); and a control device (60) which is configured to control the welding power supply device (40) and the wire feeding device (30), wherein the remote controller (50) has a sensor and is configured to output a signal corresponding to a load applied to the sensor (51) to the control device (60), and the control device (60) is configured to control the wire feeding device (30) so as to feed the filler wire (W) at a feeding speed set according to an output intensity of the signal.

### TECHNICAL FIELD

The present invention relates to a welding system.

### BACKGROUND ART

For example, when welding a structure (workpiece to be welded) using a metal, a nonferrous metal or the like as a base material, non-consumable electrode type gas shield arc welding which has been called GTAW (Gas Tungsten Arc welding) such as TIG welding (Tungsten Inert Gas welding) or plasma arc welding is used.

In addition, consumable electrode type gas shielded arc welding called GMAW (Gas Metal Arc welding) such as MIG welding (Metal Inert Gas welding), MAG welding (Metal Active Gas welding) or carbon dioxide gas arc welding is also used. The consumable electrode type gas shielded arc welding is also called semi-automatic arc welding, because welding is performed manually while automatically feeding a filler wire, which is a consumable electrode.

In these welding methods, welding is generally performed by using a welding torch, generating an arc between the electrode and a workpiece (base material), melting the workpiece by the heat of the arc, and forming a molten pool (pool). During welding, a shielding gas is discharged from a torch nozzle surrounding the electrode to block the atmosphere (air) by the shield gas.

In these welding methods, when welding a groove or a fillet, in order to secure a predetermined leg length or throat thickness, a filler wire which is a filler metal, is fed to supply deficient weld metal.

For example, in TIG welding, it is possible to separately control the melting of the base material by the arc and the feeding of the filler wire to the molten pool. As a result, the base metal can be melted by a stable arc from the tungsten electrode (non-consumable electrode), so high quality welding can be performed.

By the way, at the site where the welding operation is carried out, a welding worker often performs welding at a place away from the welding machine. For this reason, the welding worker adjusts the welding conditions, such as a welding current and a feeding speed of a filler wire, using a remote controller extended to the hands of the welding worker, or a remote controller integrally incorporated in the welding torch, (for example, Patent Documents 1 to 3).

However, since the feeding speed of the filler wire cannot be variably adjusted during welding with conventional remote controllers, there is a disadvantage that usability is bad. For example, the set feeding speed of the filler wire is fixed to three conditions of “start”, “main welding”, and “crater”.

Therefore, when there is unevenness in the clearance of the groove, the feeding speed of the filler wire cannot be changed according to the width of the clearance in the middle of welding. For this reason, there is a possibility that beads melt down when reaching a wide clearance. In contrast, at the time when the welding reaches a narrow clearance, the feeding speed of the filler wire cannot be reduced and there is a possibility that the back beads are not formed. In addition, in the over-welding of a fixed pipe, although it is desired to raise the feeding speed of the filler wire, it is impossible to change the feeding speed of the filler wire even if it reaches a point where the speed is desired to be increased.

Furthermore, the welding worker must operate the remote controller while holding the welding torch with a leather gloved hand. It is extremely difficult to adjust the feeding speed of the filler wire while finely operating the volume switch or the like provided on the remote controller.

### PRIOR ART DOCUMENTS

### Patent Literature

Patent Document 1 Japanese Unexamined Patent Application, First Publication No. 2015-202498

Patent Document 2 Japanese Unexamined Patent Application, First Publication No. Hei 10-52755

Patent Document 3 Japanese Patent No. 5001536

### SUMMARY OF INVENTION

### Problem to be Solved by the Invention

The present invention has been made in view of such conventional circumstances, and an object of the present invention is to provide a welding system having a remote controller suitable for manually adjusting the feeding speed of a filler wire.

### Means for Solving the Problem

In order to achieve the above object, the present invention provides the following welding systems.

(1) A welding system including:

a consumable electrode type or a non-consumable electrode type welding torch;

a welding power supply device which is configured to supply a welding current to the welding torch;

a wire feeding device which is configured to feed a filler wire to the welding torch or a filler guide attached to the welding torch;

a remote controller which is configured to manually adjust a feeding speed of the filler wire; and

a control device which is configured to control the welding power supply device and the wire feeding device,

wherein the remote controller has a sensor and is configured to output a signal corresponding to a load applied to the sensor to the control device, and

the control device is configured to control the wire feeding device so as to feed the filler wire at a feeding speed set according to an output intensity of the signal.

(2) The welding system according to (1), wherein the control device is configured to control the welding power supply device so as to supply a welding current set according to a feeding speed of the filler wire to the welding torch.
(3) The welding system according to (1) or (2), wherein the remote controller has a function of adjusting the output intensity of the signal corresponding to the load applied to the sensor.
(4) The welding system according any one of (1) to (3), the remote controller has a nonresponsive section in which the signal is not output until the load applied to the sensor exceeds a certain value from 0.
(5) The welding system according to (4), wherein the remote controller has a function of adjusting the nonresponsive section.
(6) The welding system according to any one of (1) to (5), wherein the control device is configured to control the welding power supply device and the wire feeding device so as to perform a terminal processing for finishing welding when the output intensity of the signal decreases to a certain value during welding.
(7) The welding system according to any one of (1) to (6), wherein the control device is configured to control the welding power supply device and the wire feeding device so as to stop welding when the output intensity of the signal decreases beyond a certain speed.
(8) The welding system according to any one of (1) to (7), wherein the sensor is a strain gauge.
(9) The welding system according to any one of (1) to (7), wherein the sensor is a pressure-sensitive sensor.
(10) The welding system according to any one of (1) to (7), wherein the sensor has a function of adjusting an amount of the signal output from the sensor.
(11) The welding system according to any one of (1) to (10), wherein the remote controller is integrally or separately attached to the welding torch and operated by a hand operating the welding torch.
(12) The welding system according to any one of (1) to (10), wherein the remote controller is operated separately from a hand operating the welding torch.
(13) A welding system including:

a consumable electrode type or a non-consumable electrode type welding torch;

a welding power supply device which is configured to supply a welding current to the welding torch;

a wire feeding device which is configured to feed a filler wire to the welding torch or a filler guide attached to the welding torch;

a remote controller which is configured to manually adjust a feeding speed of the filler wire; and

a control device which is configured to control the welding power supply device and the wire feeding device,

wherein the remote controller has a switch for stopping feeding of the filler wire so that the feeding of the filler wire can be stopped during welding.

(14) A welding system including:

a consumable electrode type or a non-consumable electrode type welding torch;

a welding power supply device which is configured to supply a welding current to the welding torch;

a wire feeding device which is configured to feed a filler wire to the welding torch or a filler guide attached to the welding torch;

a remote controller which is configured to manually adjust a feeding speed of the filler wire; and

a control device which is configured to control the welding power supply device and the wire feeding device,

wherein the remote controller has a switch for starting feeding of the filler wire and the feeding of the filler wire can be arbitrary started during welding.

(15) The welding system according to (14), wherein the switch for starting feeding of the filler wire has a function of adjusting an amount of a signal to be output when the switch is pushed.

### Effects of the Invention

According to the present invention, it is possible to provide a welding system provided with a remote controller suitable for manually adjusting a feeding speed of a filler wire.

### BRIEF DESCRIPTION OF DRAWINGS

FIG. 1 is a schematic diagram showing a welding system according to an embodiment of the present invention.

FIG. 2 is a graph showing a relationship between a load applied to a sensor and an output signal.

FIG. 3 is a graph for explaining a case in which it is determined as an emergency from a signal output from a sensor.

FIG. 4 is a graph for explaining a case in which it is determined that a welding is finished from a signal output from a sensor.

FIG. 5A is a diagram for explaining control of a feeding speed of a wire, and is a diagram showing a relationship between a sensor, a control device, and a wire feeding device.

FIG. 5B is a diagram for explaining control of a feeding speed of a wire, and is a diagram showing a case in which a sensor has a function of adjusting an amount of a signal to be output.

FIG. 5C is a diagram for explaining control of a feeding speed of a wire, and shows a case in which a remote controller has a switch for stopping wire feeding and wire feeding can be stopped during welding, or a case in which a remote controller has a switch for starting wire feeding and wire feeding can be arbitrarily started during welding.

FIG. 5D is a diagram for explaining control of a feeding speed of a wire, and shows a case in which when a switch for starting wire feeding has a device which is configured to adjusting an amount of a signal to be output, when the switch is pressed.

### DETAILED DESCRIPTION OF THE PREFERRED EMBODIMENTS

Hereinafter, embodiments of the present invention will be described in detail with reference to the drawings.

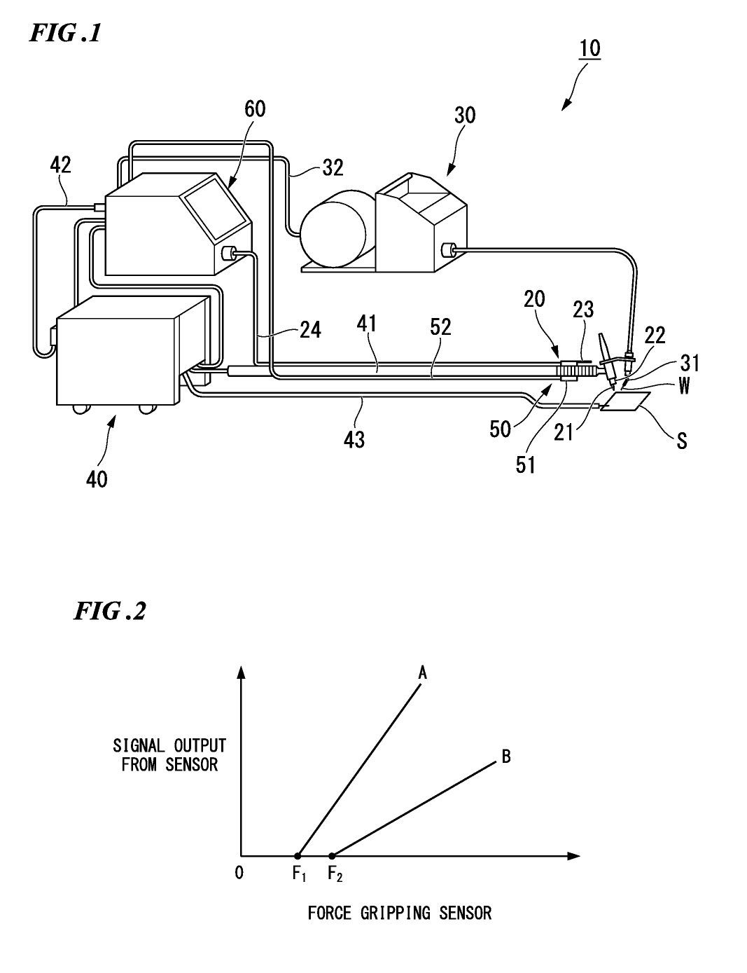

As an embodiment of the present invention, for example, the welding system 10 shown in FIG. 1 will be described. FIG. 1 is a schematic diagram showing the welding system 10.

As shown in FIG. 1, the welding system 10 of this embodiment mainly includes a welding torch 20, a wire feeding device 30, a welding power supply device 40, a remote controller 50, and a control device 60.

The welding torch 20 is a non-contact type welding torch (TIG welding torch) which is generally used conventionally, and includes a non-consumable electrode 21 which is configured to generate an arc between the welding torch 20 and a workpiece (base metal) S, and a torch nozzle 22 which is configured to emit a shielding gas toward a molten pool (pool) of the workpiece S generated by the arc.

In addition, the welding torch 20 has a torch switch 23 for switching on/off (ON/OFF) of operation. A torch switch 23 is electrically connected to the control device 60 via a torch switch cable 24.

The wire feeding device 30 has a filler guide 31 attached to the welding torch 20 and feeds a filler wire W from the tip of the filler guide 31 toward the molten pool of the workpiece S. The wire feeding device 30 is electrically connected to the control device 60 via a control cable 32.

The welding power supply device 40 is a DC type and/or AC type power supply device for TIG welding which has commonly used. The welding power supply device 40 is connected to the welding torch 20 via a welding cable 41, and supplies electric power and a shield gas to the welding torch 20. The welding power supply device 40 is electrically connected to the control device 60 via a control cable 42.

The cooling method of the welding torch 20 may be either a water cooling type method or an air cooling type method. In the case of the water cooling type method, a cooling device (chiller) is provided so that the welding torch 20 can be cooled by circulation of a cooling water (cooling liquid).

In the welding power supply device 40, the non-consumable electrode 21 is electrically connected to the minus (−) terminal side via the welding cable 41 and an workpiece S to be welded is electrically connected to the plus (+) terminal side via a base material side cable 43.

The remote controller 50 manually adjusts the feeding speed of the filler wire W, and has a sensor 51 attached to the welding torch 20. The sensor 51 is a strain gauge and is electrically connected to the control device 60 via a control cable 52. That is, using a strain gauge, a weak voltage generated by a welding worker's force applied to the sensor 51 is amplified by the amplifier, and the voltage is utilized for controlling the feeding speed of the wire.

The control device 60 controls the wire feeding device 30 and the welding power supply device 40. It is possible to adjust the welding current and the feeding speed of the filler wire W, which will be described later, according to the welding conditions via the remote controller 50 and the control device 60 at the hand of the welding worker.

In the welding system 10 having the above configuration, an arc is generated between the workpiece S and the non-consumable electrode 21 by using the welding torch 20, the workpiece S is melted by the heat of the arc, and welding is performed while forming a molten pool (pool).

During welding, a shielding gas is discharged from the torch nozzle 22 surrounding the periphery of the non-consumable electrode 21, and welding is performed while blocking the atmosphere (air) with the shielding gas. As the shielding gas, for example, an inert gas such as argon or helium can be used singly or a mixture of a plurality of inert gases. Further, it is also possible to add hydrogen, nitrogen or the like to the shielding gas. In the present invention, since oxidation gas is not used, oxidation of beads formed on the workpiece can be reduced and wettability can also be improved.

Further, during welding, the filler wire W is automatically fed toward the molten pool of the workpiece S and welding is performed while melting the filler wire W in the arc. In the present embodiment, since the filler wire W is automatically fed, it is unnecessary to simultaneously supply the filler wire and operate the welding torch 20 with the left and right hands, and it is possible to stably perform welding easily without skillful technique.

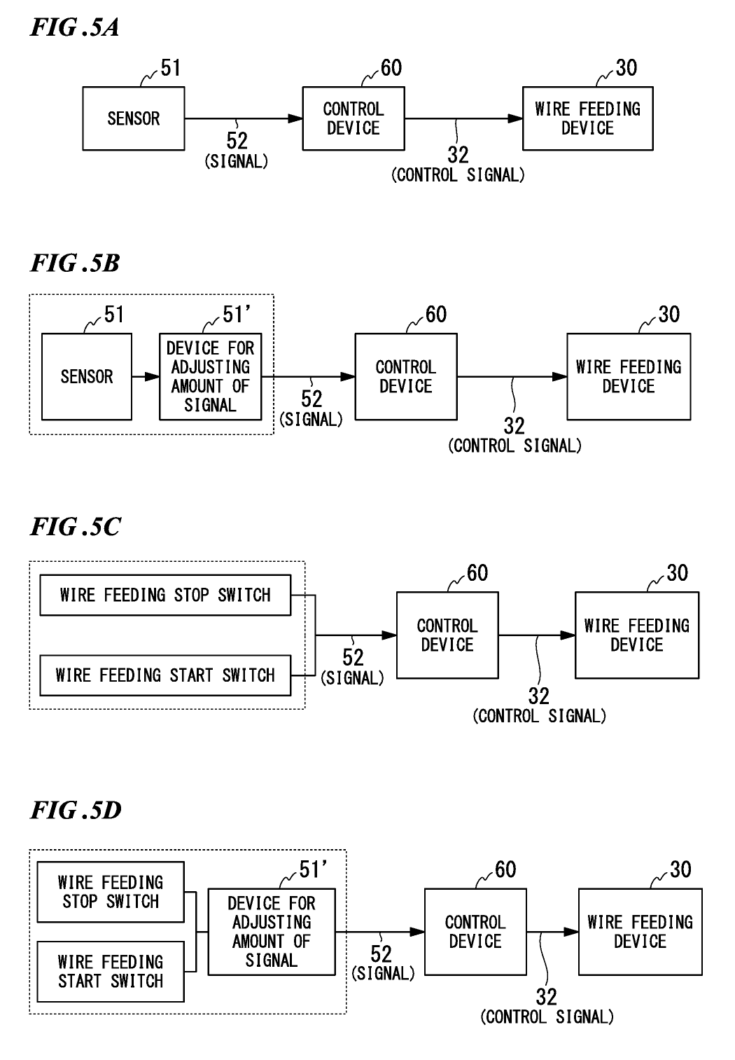

In the welding system 10 of the present embodiment, as shown in FIG. 5A, a signal corresponding to a load applied to the sensor 51 is output to the control device 60 via the control cable 52. The control device 60 controls the wire feeding device 30 by a control signal via the control cable 32 so as to feed the filler wire W at a feeding speed set according to an output intensity of the signal.

The load applied to the sensor 51 is proportional to the force applied to the sensor 51 when the welding worker grips the welding torch 20, and the sensor 51 outputs the signal having an intensity corresponding to the strength (load) gripping the welding torch 20.

The first requirement required for the sensor 51 of the present embodiment is insensitive responsiveness. Further, it is also necessary to freely set an operation lower limit value of the sensor 51. In the field of welding targeted by the present invention, thick leather gloves are always used to protect welding workers. Therefore, since the welding torch 20 is grasped and operated by the hand gloved, it cannot expect a sensitive sensation like bare hands.

Further, it is difficult to adjust the feeding speed of the filler wire W with a sensor that reacts sensitively as soon as a hand touches it. It is preferable that the sensor 51 have a nonresponsive section (so-called play) in which no signal is output from when starting to grasp the welding torch 20 with the hand gloved at the beginning of the welding to when the sensor 51 actually outputs the signal. However, in the case of using a pressure sensitive sensor for controlling the strength of electric resistance, it is not necessary to provide the nonresponsive period.

That is, it is required that after a certain amount or more of the gripping force (load) is applied to the sensor 51 after intentionally pushing or grasping the sensor 51 attached to the welding torch 20, the signal corresponding to the gripping force is output and the filler wire W is fed at a feeding speed corresponding to the output intensity of the signal.

Therefore, the sensor 51 which detects the force applied and converts the applied force into an electric signal and outputs the electric signal, as the strain gauge above, is suitable in the present embodiment. Further, as long as the sensor 51 has such a function, it is not necessarily limited to the above-described strain gauge, but other sensors such as an optical sensor and a pressure sensor may be used. However, in a case of using an optical sensor, it is necessary to devise a sensor so as not to cause a situation in which in an emergency to be described later, an armor such as a leather glove is erroneously detected, and thereby it is not possible to property judge that the current situation is an emergency.

The relationship between the load applied to the sensor 51 and the output signal is shown in FIG. 2. The horizontal axis of the graph shown in FIG. 2 is the load applied to the sensor 51, that is, the force gripping the sensor 51. On the other hand, the vertical axis of the graph shown in FIG. 2 is the intensity of the signal output from the sensor 51.

The remote controller 50 has a function of adjusting the output intensity of the signal corresponding to the load applied to the sensor 51. In addition, the remote controller 50 has a nonresponsive section (play) for not outputting the signal until the load applied to the sensor 51 exceeds a certain value from 0 (no load) and further has a function of adjusting the play.

Graphs A and B in FIG. 2 show the forces F₁ and F₂ (lower limit values of operation of the sensor 51) from when the welding worker grasps the welding torch 20 until the signal is actually output from the sensor 51, and the output intensity of the signal corresponding to the force applied to the sensor 51.

The graph A shows a case in which the sensor 51 is set such that the output of the signal from the sensor 51 is started by application of a relatively small force F₁ and a relatively large signal is output as the force applied to the sensor 51 increases.

Such a setting is suitable when it is necessary to adjust the feeding speed of the filler wire W to a relatively large value. More specifically, it is suitable for welding under welding conditions such as penetration welding, for example, temporary welding and butt welding among the weldings.

On the other hand, the graph B shows a case in which the sensor 51 is set such that the sensor 51 does not actuate unless a relatively large force F₂ is applied, and the output of the signal is not changed significantly even if the force applied to the sensor 51 increases.

Such a setting is suitable when fine adjustment is required for the feeding speed of the filler wire W. More specifically, it is suitable for welding in a welding condition of relatively high welding rate among the weldings.

In the welding system 10 of the present embodiment, the filler wire W is fed at a feeding speed set in advance according to the output intensity of the signal output from the sensor 51. Therefore, it is possible to arbitrarily adjust how much the feeding speed of the filler wire W changes according to the force gripping the sensor 51. In addition, it is also possible to arbitrarily adjust the nonresponsive section (play) from when the sensor 51 is grasped until the sensor 51 reacts.

Further, in the welding system 10 of the present embodiment, the control device 60 may control the welding power supply device 40 so that the welding current set according to the feeding speed of the filler wire W is supplied to the welding torch 20.

In actual welding, the balance between the feeding speed of the filler wire W and the welding current is important. In the welding system 10 of the present embodiment, the welding conditions can be further improved by controlling the welding power supply device 40 with the control device 60 so that the most suitable welding current is supplied to the welding torch 20 according to the feeding speed of the filler wire W.

Further, in the welding system 10 of the present embodiment, the control device 60 may control the wire feeding device 30 and the welding power source device 40 so that the welding is stopped when the output intensity of the signal decreases beyond a certain speed.

The second requirement required for the sensor 51 of the present embodiment is safety.

Since welding is performed under high temperatures and high currents, when a welding worker releases the welding torch 20 due to safety problems, it is necessary to stop the welding immediately and certainly after judging that it is an emergency.

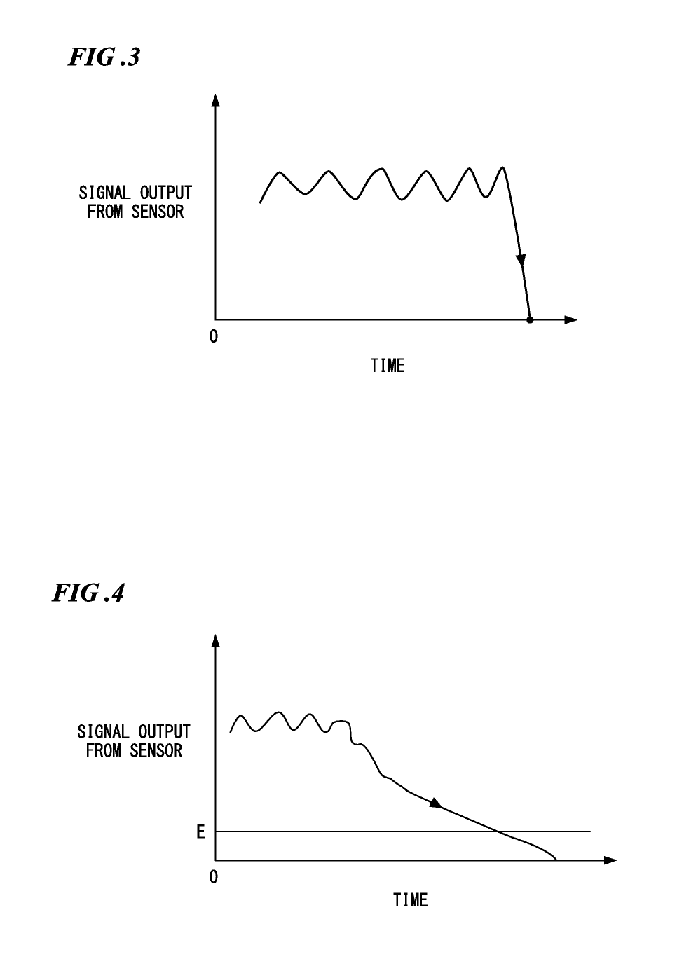

Here, a case of judging that it is an emergency will be described with reference to the graph shown in FIG. 3.

For example, when the welding worker consciously or unintentionally releases the welding torch 20, the signal output from the sensor 51 suddenly drops. Therefore, when the decrease rate (signal decrease amount/time) of the signal output from the sensor 51 exceeds a certain value, it is determined that an emergency has occurred and the welding current supplied to the welding torch 20 and the feeding of the filler wire W can be immediately stopped.

In a case of using the strain gauge and the pressure sensitive sensor as the sensor 51, when the welding worker releases the welding torch 20, the signal output from the sensor 51 certainly decreases, therefore, it is very suitable for applying safety measures to use the strain gauge and the pressure sensitive sensor as the sensor 51 of the present embodiment.

In addition, in the welding system 10 of the present embodiment, the control device 60 may control the wire feeding device 30 and the welding power supply device 40 such that a terminal processing for terminating welding is performed when the output intensity of the signal decreases to a certain value during welding.

The term “terminal processing” means to adjust the welding current and the feeding speed of the filler wire W or change the supply condition of the shielding gas so that no crater or the like will be generated at the welded portion at the end of welding. Specifically, the content of terminal processing varies depending on welding conditions (material of base material, welding method, etc.). For this reason, although not particularly limited, examples of the terminal processing include a processing of decreasing/stopping the welding current in a stepwise manner, temporarily stopping only the feeding of the filler wire W, a processing of changing the supply conditions or the gas composition of the shielding gas.

A case in which it is determined that the welding is finished will be explained with reference to the graph shown in FIG. 4. For example, when the signal output from the sensor 51 decreases to a certain value E during welding, it is determined that the welding has ended, and the feeding speed of the filler wire W and the welding current supplied to the welding torch 20 are automatically adjusted so as to satisfy the aforementioned terminal processing conditions.

The case in which a strain gauge is used as the sensor 51 of the present embodiment has been described. However, it is also possible to use a pressure sensitive sensor as the sensor 51. That is, the resistance value of the pressure sensitive sensor changes as the welding worker applies a force to the sensor 51, the change is captured as a change in the current value, and the change in a current value can be used to control the feeding speed of the wire. In other words, any objects which detect forces, operations, movements, etc. applied to the sensor 51 by the welding worker, the type of sensor and the physical quantity (current, voltage, resistance value, etc.) to be used are not limited.

As described above, the welding system 10 of the present embodiment is provided with the remote controller 50 which is suitable for manually adjusting the feeding speed of the filler wire W. By using the remote controller 50, it is possible to variably adjust the feeding speed of the filler wire W, to stop welding in case of emergency, and to perform the terminal processing after welding.

It should be noted that the present invention is not necessarily limited to the above embodiment, and various modifications can be made without departing from the spirit of the present invention.

For example, the remote controller 50 is not limited to a configuration in which the sensor 51 is separately attached to the welding torch 20 described above, and the sensor 51 may be integrally attached to the welding torch 20.

That is, the remote controller 50 may be integrally incorporated in the welding torch 20. For example, in the welding torch 20, in place of the torch switch 23, it is possible to incorporate a function of switching ON/OFF of the operation of the welding torch 20 in the remote controller 50.

In this case, first, the welding worker grips the welding torch 20, whereby the operation of the welding torch 20 is turned on (ON). However, in this state, since the signal from the sensor 51 is equal to or less than the operation lower limit value of the sensor 51, feeding of the filler wire W is not started.

Next, from this state, the welding worker strengthens the force of grasping the welding torch 20, whereby the filler wire W is fed at the feeding speed corresponding to the grasping force. Then, at the end of welding, the welding worker weakens the force of grasping the welding torch 20, whereby the operation of the welding torch 20 is turned off (OFF) after the terminal processing.

In addition, the remote controller 50 is not limited to a configuration that is operated by a hand grasping the welding torch 20 of the welding worker. The remote controller 50 may be configured to be operated separately from the hand operating the welding torch 20. For example, it is possible to manipulate the sensor 51 with the remote controller 50 held on the hand opposite to the hand operating the welding torch 20, or step on the sensor 51 of the remote controller 50 installed separately from the welding torch 20 with the foot.

In the remote controller 50, the sensor 51 outputs the signal according to the force (load) for grasping the welding torch 20 described above. However, for example, the sensor 51 may be formed in a button shape, and the sensor 51 may output the signal in response to the pressing force of the sensor 51.

The sensor 51 used for the remote controller 50 may have a function of adjusting the amount of the signal output from the sensor 51. The term “amount of the signal” refers to the size of the signals itself or the number of the signals within a unit time. For example, it can be combined with a pressure sensitive sensor and an analog type or digital type variable resistor. With this combination, even if the force (grasping force) applied to the pressure sensitive sensor is the same, the feeding speed of the filler wire W can be adjusted by adjusting the magnitude of the signal output from the sensor. As shown in FIG. 5B, when the sensor 51 includes a device 51 which is configured to adjust the amount of the signal output from the sensor 51, the adjusted signal is output to the control device 60 via the control cable 52, and the control device 60 outputs the control signal to the wire feeding device 30 via the control cable 32 on the basis of the adjusted signal. That is, the feeding speed of wire is controlled based on the amount of the adjusted signal.

In the present invention, during welding, the wire feeding may be stopped by a wire feeding stop switch provided with the remote controller 50, or the wire feeding may be started by a wire feeding start switch provided with the remote controller 50. In this case, as shown in FIG. 5C, a signal from the wire feeding stop switch or the wire feed start switch is output to the control device 60 via the control cable 52, and the control device 60 starts or stops the feeding of the wire to the wire feeding device based on the signal.

In other words, instead of adjusting the feeding speed of the wire itself, the amount of the wire supplied per unit time may be adjusted and the feeding speed itself of the wire may be substantially adjusted by alternately using the wire feeding stop switch (wire feeding stop) and the wire feeding start switch (wire feeding start).

In addition, when the wire feeding stop switch or the wire feeding start switch is pressed, the feeding speed of the wire may be adjusted by adding a function of adjusting the amount of the signal sent to the control device. In this case, as shown in FIG. 5D, after adjusting the signal from the wire feeding stop switch or the wire feeding start switch with the device 51′ which is configured to adjust the amount of the signal, the adjusted amount of the signal is sent to the control device 60 via the control cable 52. In response to the signal, the control device 60 outputs the control signal to the wire feeding device, and the feeding speed of the wire is adjusted on the basis of the control signal.

Further, the welding system according to the present invention is not limited to the TIG welding explained above. The welding system according to the present invention can be used in a welding system such as MAG welding and MIG welding using a consumable electrode type welding torch in addition to the TIG welding.

### EXPLANATION OF REFERENCE NUMERAL

10 welding system
20 welding torch
30 wire feeding device
40 welding power supply device
50 remote controller
51 sensor
51′ device for adjusting amount of signal
60 control device
S workpiece
W filler wire

1. A welding system including:
a consumable electrode type or a non-consumable electrode type welding torch;
a welding power supply device which is configured to supply a welding current to the welding torch;
a wire feeding device which is configured to feed a filler wire to the welding torch or a filler guide attached to the welding torch;
a remote controller which is configured to manually adjust a feeding speed of the filler wire; and
a control device which is configured to control the welding power supply device and the wire feeding device,
wherein the remote controller has a sensor and is configured to output a signal corresponding to a load applied to the sensor to the control device, and
the control device is configured to control the wire feeding device so as to feed the filler wire at a feeding speed set according to an output intensity of the signal.

2. The welding system according to claim 1, wherein the control device is configured to control the welding power supply device so as to supply a welding current set according to a feeding speed of the filler wire to the welding torch.

3. The welding system according to claim 1, wherein the remote controller has a function of adjusting the output intensity of the signal corresponding to the load applied to the sensor.

4. The welding system according claim 1, the remote controller has a nonresponsive section in which the signal is not output until the load applied to the sensor exceeds a certain value from 0.

5. The welding system according to claim 4, wherein the remote controller has a function of adjusting the nonresponsive section.

6. The welding system according to claim 1, wherein the control device is configured to control the welding power supply device and the wire feeding device so as to perform a terminal processing for finishing welding when the output intensity of the signal decreases to a certain value during welding.

7. The welding system according to claim 1, wherein the control device is configured to control the welding power supply device and the wire feeding device so as to stop welding when the output intensity of the signal decreases beyond a certain speed.

8. The welding system according to claim 1, wherein the sensor is a strain gauge.

9. The welding system according to claim 1, wherein the sensor is a pressure-sensitive sensor.

10. The welding system according to claim 1, wherein the sensor has a function of adjusting an amount of the signal output from the sensor.

11. The welding system according to claim 1, wherein the remote controller is integrally or separately attached to the welding torch and operated by a hand operating the welding torch.

12. The welding system according to claim 1, wherein the remote controller is operated separately from a hand operating the welding torch.

13. A welding system including:
a consumable electrode type or a non-consumable electrode type welding torch;
a welding power supply device which is configured to supply a welding current to the welding torch;
a wire feeding device which is configured to feed a filler wire to the welding torch or a filler guide attached to the welding torch;
a remote controller which is configured to manually adjust a feeding speed of the filler wire; and
a control device which is configured to control the welding power supply device and the wire feeding device,
wherein the remote controller has a switch for stopping feeding of the filler wire so that the feeding of the filler wire can be stopped during welding.

14. A welding system including:
a consumable electrode type or a non-consumable electrode type welding torch;
a welding power supply device which is configured to supply a welding current to the welding torch;
a wire feeding device which is configured to feed a filler wire to the welding torch or a filler guide attached to the welding torch;
a remote controller which is configured to manually adjust a feeding speed of the filler wire; and
a control device which is configured to control the welding power supply device and the wire feeding device,
wherein the remote controller has a switch for starting feeding of the filler wire and the feeding of the filler wire can be arbitrary started during welding.

15. The welding system according to claim 14, wherein the switch for starting feeding of the filler wire has a function of adjusting an amount of a signal to be output when the switch is pushed.
